(19) United States
(12) Patent Application Publication
(10) Pub. No.: US 2002/0193507 A1
(43) Pub. Date: Dec. 19, 2002

(54) Polyurethane dispersion with high film hardness, process for preparing it, and its use

(76) Inventor: Gerhard Reusmann, Essen (DE)

Correspondence Address: William F. Lawrence, Esq., c/o FROMMER LAWRENCE & HAUG LLP, 745 Fifth Avenue, New York, NY, 10151, US

(21) Appl. No.: 10/096,721

(22) Filed: Mar. 13, 2002

(30) Foreign Application Priority Data
Mar. 15, 2001 (DE) 101 12 390.6

(51) Int. Cl. C08K 3/00

(52) U.S. Cl. 524/589

(57) ABSTRACT

A description is given of a polyurethane (hybrid) dispersion with high film hardness, high flexibility and good emulsion stability which comprises the following reaction components:

(A) from 3 to 25% by weight of a polyol component consisting of

(i) from 2 to 20% by weight of a polymeric polyol having two or more polyisocyanate-reactive hydroxyl groups and a molar mass of from 500 to 4 000 daltons

(ii) from 0.5 to 5% by weight of a low molecular mass polyol having two or more polyisocyanate-reactive hydroxyl groups and a molar mass of from 50 to 500 daltons

(B) from 3 to 30% by weight of an anionically modifiable 1,2-polymethacrylatediol,

(C) from 2 to 20% by weight of a polyisocyanate component,

(D) from 0 to 6% by weight of a solvent component,

(E) from 0.15 to 1.5% by weight of a neutralizing component composed of at least one organic or inorganic base,

(F) from 0 to 1% by weight of a chain extender component composed of one or more polyamines having two or more polyisocyanate-reactive amino groups,

and, optionally

(G) from 5 to 40% by weight of a monomer component,

(H) from 0.01 to 1.5% by weight of an initiator component,

and water as the remainder.

### RELATED APPLICATIONS

This application claims priority to German application No. 101 12 390.6, filed Mar. 15, 2001, herein incorporated by reference.

### BACKGROUND OF THE INVENTION

1. Field of the Invention

The present invention relates to an aqueous polyurethane dispersion having high emulsion stability, high dried-film hardness, and high flexibility and also to its use as a binder for one- or two-component coating materials, seals, adhesive bonds, and coatings.

2. Description of the Related Art

Coating systems based on aqueous polyurethane dispersions and polyurethane/polymer hybrid dispersions have gained increasingly in importance in recent years owing to their good properties such as adhesion to different substrates, abrasion resistance, and also flexibility and toughness. The preparation of aqueous polyurethanes has been known for many years and is described in detail in a great number of publications, e.g., Houben-Weyl, Methoden der organischen Chemie, Volume E 20, Part I, pp. 1659-1681; D. Dieterich, Prog. Org. Coat. 1981, 9, 281-330; J. W. Rosthauser, K. Nachtkamp, Journal of Coated Fabrics 1986, 16, 39-79; R. Arnoldus, Surf. Coat. 1990, 3 (Waterborne Coat.), 179-98.

The polyurethane/polymer hybrid dispersions, which are more favorable in cost terms than polyurethane dispersions, are particularly suitable for the coating, sealing, and adhesive bonding of the surfaces of metallic and mineral substrates and also of wood-base materials and plastics. The polyurethane/polymer hybrid dispersions represent synergistic combinations of straight polyurethane dispersions and straight polymer dispersions, whose profile of properties cannot be achieved by a simple blending of the two types of dispersion. Polyurethane/polymer hybrid dispersions are based on interpenetrating networks of polyurethane polymers and acrylic polymers, which may be linked with one another both physically and chemically. This type of dispersion requires specific synthesis methods. Straight polyurethane dispersions are too expensive for numerous applications. In the polyurethane/polymer hybrid dispersions, therefore, the advantageous properties of the straight polyurethane dispersions are united with the cost advantage of the straight polymer dispersions. For these reasons, the more cost-effective polyurethane/polymer hybrid dispersions are gaining more and more in importance relative to conventional polyurethane dispersions in, for example, building applications.

The commercially dominant anionically charged polyurethane dispersions are prepared by using dihydroxy-functional carboxylic acids. The acid group may be neutralized with a base, such as triethylamine, and so converted into a hydrophilic carboxylate group. One dihydroxy-functional carboxylic acid frequently used is dimethylolpropionic acid (DMPA). As a result of the sterically hindered carboxyl group, the isocyanate reaction takes place preferentially with the hydroxyl groups.

M. L. Manock describes in Pigment & Resin Technology, Vol. 29, No. 3, (2000), pp. 143-151 how the amount of DMPA is critical, since dispersibility and the particle size of the resulting polyurethane dispersions are influenced. Likewise described is the increase in water sensitivity and hence in water solubility of the dried films as a result of increasing the hydrophilic centers.

The laws applying to the polyurethane/polyacrylate hybrid dispersions, obtainable by a variety of preparation processes, are similar to those for the polyurethane dispersions, since the polyurethane resin acts as an emulsifying constituent for the polyacrylate.

M. L. Manock (loc. cit.) describes the advantages of the hybrids in comparison to physical mixtures of polyurethane and polyacrylate and further describes the variety of synthesis pathways, such as graft polymers, polyurethane interpenetrating networks (IPNs), and preparation by sequential polymerization.

In accordance with the state of the art, therefore, the typically used carboxyl-containing polyols, such as dimethylolpropionic acid (DMPA), will not permit controlled adjustment of the ratio of soft segments to hard segments, since the concentration in which the dispersing polyols are used essentially influences the properties of the dispersions and of the dried films. Simultaneous controlled influencing of the parameters of flexibility, hardness, dispersion stability, and water sensitivity is therefore not possible to the desired extent.

### OBJECT OF THE INVENTION

It is an object of the present invention to provide a polyurethane dispersion and/or a polyurethane hybrid dispersion combining high film hardness with high flexibility levels and good chemical resistance that does not have the abovementioned disadvantages of the state of the art and at the same time permits a wide scope for variation in the introduction of neutralizable carboxyl groups.

### SUMMARY OF THE INVENTION

This object and others have been achieved in accordance with the invention by the polyurethane dispersion comprising the following reaction components:

(A) from about 3 to about 25% by weight of a polyol component composed of

(i) from about 2 to about 20% by weight of a polymeric polyol having two or more polyisocyanate-reactive hydroxyl groups and a molar mass of from about 500 to about 4,000 daltons

(ii) from about 0.5 to about 5% by weight of a low molecular mass polyol having two or more polyisocyanate-reactive hydroxyl groups and a molar mass of from about 50 to about 500 daltons

(B) from about 3 to about 30% by weight of an anionically modifiable 1,2-polymethacrylate diol having two polyisocyanate-reactive hydroxyl groups and also one or more carboxyl groups which are inert toward polyisocyanates, and having a molar mass of from about 500 to about 5,000 daltons,

(C) from about 2 to about 20% by weight of a polyisocyanate component composed of one or more polyisocyanates, polyisocyanate homologs or polyisocyanate derivatives having two or more aliphatic or aromatic isocyanate groups,

(D) from 0 to about 6% by weight of a solvent component consisting of

(i) at least one polyisocyanate-inert organic solvent which following the preparation of the polyurethane/polymer hybrid dispersion remains therein or is removed in part or in whole by distillation and/or

(ii) from 0 to about 6% by weight of a polyisocyanate-inert reactive diluent composed of at least one polyisocyanate-inert organic compound having one or more free-radically polymerizable double bonds,

(E) from about 0.15 to about 1.5% by weight of a neutralizing component consisting of at least one organic or inorganic base,

(F) from 0 to about 1% by weight of a chain extender component consisting of one or more polyamines having two or more polyisocyanate-reactive amino groups, and water as the remainder.

Polyurethane/polymer hybrid dispersions of the invention further comprise the following reaction components:

(G) from about 5 to about 40% by weight of a monomer component composed of one or more monomers having one or more free-radically polymerizable double bonds,

(H) from about 0.01 to about 1.5% by weight of an initiator component composed of at least one lipophilic free-radical initiator which has a half-life of at least one hour at a decomposition temperature in the range from about 40 to about 120° C.

Both forms of the dispersions are referred to hereinafter as polyurethane (hybrid) dispersion.

It has surprisingly been found that the polyurethane (hybrid) dispersion of the invention possesses very good performance properties such as high film hardness and chemical resistance and also an excellent dispersion stability.

The polyol component (A) for the synthesis of the polyurethane (hybrid) dispersion of the invention, with a fraction of from about 3 to about 20% by weight, is composed preferably of the two individual components (A) (i) and (A) (ii).

Component (A) (i), with a fraction of from about 2 to about 20% by weight, is composed of at least one relatively high molecular mass polymeric polyol having two or more polyisocyanate-reactive hydroxyl groups and an average molar mass (number average) of from about 500 to about 4,000 daltons. It may comprise polymeric polyols such as polyalkylene glycols, aliphatic or aromatic polyesters, polycaprolactones, polyearbonates, macromonomers, telechelics or epoxy resins, or mixtures thereof. Polyalkylene glycols are obtained from monomers such as ethylene oxide, propylene oxide, butylene oxide, and tetrahydrofuran by addition polymerization in the presence of boron trifluoride or by polyaddition onto starter compounds containing reactive hydrogen atoms, such as water, alcohols, amines or bisphenol A. Mixtures of the monomers may also be used simultaneously or in succession. As suitable polyalkylene glycols it is possible, for example, to use polyethylene glycols, polypropylene glycols (e.g., Voranol® grades from Dow), mixed polyglycols based on ethylene oxide and propylene oxide, and also polytetramethylene glycols and/or polytetrahydrofurans (for example, PolyTHF® 2000 from BASF). Aliphatic or aromatic polyester polyols are obtained by polycondensation reaction and/or polyaddition reaction from dihydric or higher polyhydric alcohols and dibasic or higher polybasic carboxylic acids, carboxylic anhydrides or carboxylic esters. As suitable aliphatic or aromatic polyesters it is possible, for example, to use condensates based on 1,2-ethanediol and/or ethylene glycol, 1,4-butanediol and/or 1,4-butylene glycol, 1,6-hexanediol and/or 1,6-hexamethylene glycol and 2,2-dimethyl-1,3-propanediol and/or neopentyl glycol, and also 1,6-hexanedioic acid and/or adipic acid and 1,3-benzenedicarboxylic acid and/or isophthalic acid (for example, Bester grades from Poliolchimica). Polycaprolactones (for example, Capa grades from Solvay Interox) and polycarbonates (for example, Desmophen® C 200 from Bayer) are further members of the polyester group. The former are obtained by reacting phosgene and/or aliphatic or aromatic carbonates, such as diphenyl carbonate or diethyl carbonate, with dihydric or higher polyhydric alcohols. The latter are prepared by polyaddition of lactones such as ε-caprolactone onto starter compounds containing reactive hydrogen atoms, such as water, alcohols, amines or bisphenol A. Also conceivable are synthetic combinations of polyesters, polycaprolactones, and polycarbonates. Likewise suitable are macromonomers, telechelics or epoxy resins. The macromonomers and telechelics comprise polyhydroxy olefins such as α,ω-dihydroxypolybutadienes, α,β-dihydroxy(meth)acrylic esters, α,ω-dihydroxy(meth)acrylic esters or α,ω-dihydroxy-polysiloxanes, for example. The epoxy resins comprise, preferably, derivatives of bisphenol A diglycidyl ether (BADGE). Preference is given to linear and/or difunctional aliphatic or aromatic polyester polyols having an average molecular mass (number average) of from about 1,000 to about 4,000 daltons. Particular preference is given to using difunctional and/or linear polyester polyols based on adipic acid and/or 1,6-hexanedioic acid, 1,4-butylene glycol and/or 1,4-butanediol, and ethylene glycol and/or 1,2-ethanediol.

Component (A) (ii), with a fraction of from about 0.5 to about 5% by weight, is composed of at least one low molecular mass polyol having two or more polyisocyanate-reactive hydroxyl groups and a molar mass of from about 50 to about 5,000 daltons. As suitable low molecular mass polyols it is possible, for example, to use 1,2-ethanediol and/or ethylene glycol, 1,2-propanediol and/or 1,2-propylene glycol, 1,3-propanediol and/or 1,3-propylene glycol, 1,4-butanediol and/or 1,4-butylene glycol, 1,6-hexanediol and/or 1,6-hexamethylene glycol, 2-methyl-1,3-propanediol (trade name MPDiol Glycol® from Arco Chemical), 2,2-dimethyl-1,3-propanediol and/or neopentyl glycol, 1,4-bis(hydroxymethyl)cyclohexane and/or cyclohexanedimethanol, 1,2,3-propanetriol and/or glycerol, 2-hydroxymethyl-2-methyl-1,3propanol and/or trimethylolethane, 2-ethyl-2-hydroxymethyl-1,3-propanediol and/or trimethylolpropane, 2,2-bis(hydroxymethyl)-1,3-propanediol and/or pentaerythritol. Preference is given to using 1,4-butylene glycol and/or 1,4-butanediol or 1,4-butylene glycol and/or 1,4-butanediol, if desired, in combination with trimethylolpropane and/or 2-hydroxymethyl-2-methyl-1,3-propanediol.

Component (A) (ii) may also be composed in part of at least one low molecular mass and anionically modifiable polyol having two or more polyisocyanate-reactive hydroxyl groups and one or more polyisocyanate-inert carboxyl groups which can be converted wholly or partly into carboxylate groups in the presence of bases. As low molecular mass and anionically modifiable polyols having a molecular mass of from about 100 to about 200 daltons it is possible, for example, to use 2-hydroxymethyl-3-hydroxypropanoic acid and/or dimethylolacetic acid, 2-hydroxymethyl-2-methyl-3-hydroxypropanoic acid and/or dimethylolpropionic acid, 2-hydroxymethyl-2-ethyl-3-hydroxypropanoic acid and/or dimethylolbutyric acid, 2-hydroxymethyl-2-propyl-3-hydroxypropanoic acid and/or dimethylolvaleric acid, citric acid, and tartaric acid. Preference is given to using bishydroxyalkanecarboxylic acids and more preferably 2-hydroxymethyl-2-methyl-3-hydroxypropanoic acid and/or dimethylolpropionic acid (trade name DMPA® from Malinckrodt).

Component (13), with a fraction of from about 2 to about 20% by weight, is an anionically modifiable 1,2-polymethacrylate diol of the general formula (I) having two polyisocyanate-reactive hydroxyl groups and also one or more polyisocyanate-inert carboxyl groups and a molar mass of from about 500 to about 5,000 daltons.

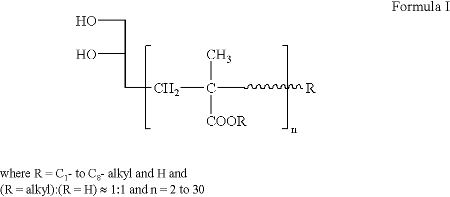

(B) is prepared by operating in accordance with processes known to the skilled worker, by free-radical copolymerization of (meth)acrylic acid and one or more alkyl (meth)acrylates using dihydroxy-functional mercapto compounds as chain transfer agents. As dihydroxy-functional mercapto compound it is preferred to use 1-mercaptoglycerol. The ratio of carboxyl-containing monomers to carboxylate group-containing monomers should be chosen such that there is on average at least one carboxyl group per molecule of component (B).

Component (C), with a fraction of from about 2 to about 20% by weight, is composed of at least one polyisocyanate, polyisocyanate derivative or polyisocyanate homolog having two or more aliphatic or aromatic isocyanate groups. Particularly suitable components are the polyisocyanates which are amply known in polyurethane chemistry, or combinations thereof. As suitable aliphatic polyisocyanates it is possible, for example, to use 1,6-diisocyanatohexane (HDI), 1-isocyanato-5-isocyanatomethyl-3,3,5-trimethylcyclohexane (IPDI), bis-(4-isocyanatocyclohexyl)methane (Hl₂ MDI), 1,3-bis(1-isocyanato-1-methylethyl)benzene (m-TMXDI) and/or technical-grade isomer mixtures of the individual aromatic polyisocyanates. As suitable aromatic polyisocyanates it is possible, for example, to use 2,4-diisocyanatotoluene (TDI), bis(4-isocyanatophenyl)methane (MDI) and, if desired, its higher homologs (polymeric MDI) and/or technical-grade isomer mixtures of the individual aromatic polyisocyanates. Also suitable in principle, furthermore, are the polyisocyanates known as “paint polyisocyanates” and based on bis(4-isocyanatocyclohexyl)methane (Hl₂ MDI), 1,6-diisocyanatohexane (HDI), and 1-isocyanato-5-isocyanatomethyl-3,3,5-trimethylcyclohexane (IPDI). The term “paint poly-isocyanates” characterizes derivatives of these diisocyanates which contain allophanate, biuret, carbodiimide, isocyanurate, uretdione or urethane groups and in which the residual monomeric diisocyanate content has been reduced to a minimum in accordance with the state of the art. In addition it is also possible to use modified polyisocyanates obtainable, for example, by hydrophilic modification of “paint polyisocyanates” based on 1,6-diisocyanatohexane (HDI). The aliphatic polyisocyanates are preferred over the aromatic polyisocyanates. Furthermore, polyisocyanates containing isocyanate groups of different reactivity are preferred. In particular, isophorone diisocyanate, with particular preference 1-isocyanato-5-isocyanatomethyl-3,3,5-trimethylcyclohexane, and more preferably still its technical-grade isomer mixtures, are used.

The solvent component (D) (i), with a fraction of from 0 to about 6% by weight, is composed, where present, of at least one polyisocyanate-inert solvent which is preferably miscible partly or fully with water and which, following the preparation, remains in the polyurethane dispersion or is removed in whole or in part by distillation. Examples of suitable solvents are high-boiling and hydrophilic organic solvents such as N-methylpyrrolidone, diethylene glycol dimethyl ether, dipropylene glycol dimethyl ether (Proglyde DMM® from Dow), low-boiling solvents such as acetone, butanone or any desired mixtures thereof. Preference is given to using a high-boiling and hydrophilic solvent such as N-methylpyrrolidone which following the preparation remains in the dispersion and acts as a coalescence aid.

The solvent component (D) (ii), with a fraction of from 0 to about 6% by weight, is composed of at least one polyisocyanate-inert reactive diluent consisting of at least one polyisocyanate-inert organic compound (such as polyethylene glycol, for example) containing one or more free-radically polymerizable double bonds. Examples of suitable solvents are derivatives of acrylic acid such as methoxypolyethylene glycol methacrylates, polyethylene glycol dimethacrylates, methyl methacrylate, n-butyl acrylate, methyl acrylate, acetoacetoxyethyl methacrylate, or polyethylene glycol methyl vinyl ether, N-vinylimidazole, and N-vinylpyrrolidone. Preference is given to using methoxy polyethylene glycol methacrylates having from about 2 to about 20 ethylene glycol units, and methacrylates.

The neutralizing component (E), with a fraction of from about 0.15 to about 1.5% by weight, is composed of one or more organic or inorganic bases which are used for the complete or partial neutralization of the carboxyl groups. As suitable bases it is possible to use tertiary amines such as N,N-dimethylethanolamine, N-methyldiethanolamine, N-methyldiisopropanolamine, dimethylisopropanolamine, N-methylmorpholine, N-ethylmorpholine, triethanolamine, triethylamine, triisopropylamine, ammonia or alkali metal hydroxides such as lithium hydroxide, sodium hydroxide, and potassium hydroxide. It is preferred to use tertiary amines and in particular triethylamine.

Using the neutralizing component (E), with a fraction of from about 0.15 to about 1.5% by weight, direct or indirect neutralization and/or anionic modification of the polyurethane prepolymers is undertaken before or during dispersion. In the case of neutralization, the carboxyl groups form carboxylate groups which are used for anionic modification of the polyurethane dispersion and polyurethane base dispersion and of the polyurethane/polymer hybrid dispersion prepared therefrom.

The chain extender component (F), with a fraction of 0%, in particular from about 0.1 to about 1%, by weight, is composed of at least one polyamine having two or more polyisocyanate-reactive amino groups. Examples of suitable polyamines are adipic dihydrazide, ethylenediamine, diethylenetriamine, triethylenetetramine, tetraethylenepentamine, pentaethylenehexamine, dipropylenetriamine, hexamethylenediamine, hydrazine, isophoronediamine, N-(2-aminoethyl)-2-aminoethanol, adducts of salts of 2-acrylamido-2-methylpropane-1-sulphonic acid (AMPS) and ethylenediamine, or any desired combinations of these polyamines. Preference is given to using difunctional primary amines, and especially 1,2-diaminoethane and/or ethylenediamine. When using the prepolymer mixing method, the chain extension of the polyurethane prepolymer dispersion leads to an increase in the molecular mass within the micelles and the formation of a polyurethane polyurea dispersion of high molecular mass. The reactive isocyanate groups react with the chain extender components substantially more quickly than with water. The isocyanate groups of the polyurethane prepolymers are converted into urea groups. Subsequently, any remaining free isocyanate groups are fully chain-extended with water. In one preferred embodiment, component (E) contains from about 20 to about 80% by weight, in particular 50% by weight, of dispersion medium (water).

The solids content of the polyurethane polymer composed of components (A) to (E) is preferably from about 20 to about 60% by weight, in particular from about 30 to about 50% by weight, based on the overall amount of the polyurethane dispersion prepared initially. The micelles of the polyurethane polymer possess a preferred average particle size of from about 50 to about 500 nm, in particular from about 100 to about 200 nm. Moreover, the polyurethane polymer has an average molar mass of preferably from about 25,000 to about 100,000 daltons.

For further reaction to give polyurethane hybrid dispersions, additional use is made of components (G) and (H):

The monomer component (G), with a fraction of from about 5 to about 40% by weight, is composed of one or more monomers having one or more free-radically polymerizable double bonds. Examples of suitable monomers are derivatives of acrylic acid such as methacrylic acid, methacrylic anhydride, methacrylonitrile, methacrylamide, methyl methacrylate, ethyl methacrylate, n-butyl methacrylate, i-butyl methacrylate, n-hexyl methacrylate, cyclohexyl methacrylate, 2-ethylhexyl methacrylate, isobomyl methacrylate, benzyl methacrylate, 2-hydroxyethyl methacrylate, hydroxypropyl methacrylate, 2-hydroxyethyl acrylate, hydroxypropyl acrylate, 2-dimethylaminoethyl methacrylate, ethyl triglycol methacrylate, tetrahydrofurfuryl methacrylate, allyl methacrylate, ethylene glycol dimethacrylate, diethylene glycol dimethacrylate, triethylene glycol dimethacrylate, tetraethylene glycol dimethacrylate, polyethylene glycol 400 dimethacrylate, 1,3-butanediol dimethacrylate, 1,4-butanediol dimethacrylate, 1,6-hexanediol dimethacrylate, methyl acrylate, n-butyl acrylate, n-hexyl acrylate, n-octyl acrylate, n-octyl methacrylate, acrylic acid, acetoacetoxyethyl methacrylate, acrylamide, N-butoxymethylmethacrylamide, N-isobutoxymethylmethacrylamide, 2-acrylamido-2-methylpropane-1-sulfonic acid (AMPS), methoxypolyethylene glycol methacrylates, methoxypolyethylene glycol acrylates, polyethylene glycol dimethacrylates or styrene derivatives such as styrene, methylstyrene, and ethylstyrene. It is preferred to use mixtures of methyl methacrylate, n-butyl acrylate, and styrene. Preference is given to using acrylic acid and/or propenoic acid and their derivatives and/or methacrylic acid and/or 2-methylpropenoic acid and their derivatives and/or styrene and its derivatives.

The initiator component (H), with a fraction of from about 0.01 to about 1.5% by weight, is composed of at least one lipophilic free-radical initiator which has a half-life of at least one hour at a decomposition temperature in the range from about 40 to about 120° C. Examples of suitable initiators are peroxide initiators such as dilauroyl peroxide, dibenzoyl peroxide, tert-amyl peroxyneodecanoate, tert-butyl peroxyneodecanoate, tert-butyl peroxypivalate, 2,5-dimethyl-2,5-di(2-ethylhexanoylperoxy)hexane, tert-amyl peroxy-2-ethylhexanoate, tert-butyl peroxy-2-ethylhexanoate, tert-amyl peroxybenzoate, tert-butyl peroxybenzoate, persulfate initiators such as ammonium peroxodisulfate, sodium peroxodisulfate, potassium peroxodisulfate, azo initiators such as 2,2′-azobis(2-cyclopropylpropionitrile), 2,2′-azobis(2,4-dimethylvaleronitrile), 2,2′-azobis(2-methylbutyronitrile), 2,2′-azobis(2-methylpropionitrile), 1,1′-azobis(cyclohexane-1-carbonitrile). Preference is given to using free-radical initiators having one or more azo or peroxo groups and a half-life of at least one hour at a decomposition temperature of from 70 to 90° C. Particular preference is given to using 2,2′-azobis(2-methylpropionitrile) and/or 2,2′-azoisobutyronitrile.

The solids content in the polyurethane/polymer hybrid dispersion is from about 20 to about 60% by weight, preferably from about 30 to about 50% by weight, based on the overall amount of the pure polyurethane/polymer hybrid dispersion. The ratio of the fractional solids contents of polyurethane resin and polymer resin is in particular from about 20:80 to about 80:20% by weight, preferably from about 40:60 to about 60:40% by weight, and with particular preference 50:50% by weight.

The polyurethane hybrid polymer possesses a preferred average molar mass of from about 25,000 to about 250,000 daltons.

The polyurethane (hybrid) dispersion of the invention is prepared using the techniques customary in polyurethane chemistry, such as, for example, the acetone process (DE-C-14 95 847), the prepolymer mixing process (DE-A-23 44 135), the melt dispersion process (U.S. Pat. No. 3,898,197) or the ketimine/ketazine process (DE-A-28 11 148). An overview of the various processes is given, for example, by D. Dieterich in Progress in Organic Coatings, 9 (1981), 281-340.

The polyurethane (hybrid) dispersion of the invention is outstandingly suitable as a binder for one- or two-component coating materials, seals, adhesive bonds, and coatings of surfaces of mineral building materials, such as concrete, wood and woodbase materials, metal, and plastics, for example.

The advantages of the polyurethane (hybrid) dispersion of the invention include, for example, high hardness coupled with high flexibility of the crack-free films, good chemical resistance, and great stability of the dispersion within a wide pH range.

Through the introduction of the carboxyl-containing poly(meth)acrylate polyols (B) it is possible to integrate two or more anionically modifiable hydrophilic carboxylate groups per molecule into the polyurethane resin. The carboxylate groups are not attached directly to the polyurethane backbone but instead, by attachment to the pendant polyacrylate, are more readily able to orient themselves into the aqueous phase.

### EXAMPLES

The examples which follow are intended to illustrate the invention in more detail.

I) Preparation of the Polyurethane Dispersions

Preparation of “dispersing diol D”

To prepare the “dispersing diol D”, 170 g of xylene were charged to a reaction vessel, which was flushed with nitrogen. The xylene charge was heated to 86° C. and 285 g of methyl methacrylate, 245 g of methacrylic acid, 75.5 g of 1-thioglycerol (3-mercapto-1,2-propanediol from Aldrich) and 1.23 g of AMBN (2,2′-azobis(2-methylbutyronitrile)) were added. Reaction was continued at from 85 to 89° C. for 2 hours until it ended.

Residual monomers were removed by vacuum distillation to a residual monomer content <1% by weight.

The polyurethane dispersions were prepared by the process known as the acetone process.

### Example 1

### Polyurethane Dispersion B

1) Polyurethane Resin P2:

A four-necked flask equipped with KPG stirrer, reflux condenser, thermometer and nitrogen blanketing was charged with 360.0 g of TEGO® Diol BD1000 (α,ω-polybutyl methacrylate diol of molar mass 1 000 g/mol from Tego Chemie Service GmbH), 5.9 g of neopentyl glycol (NPG from Neste Chemicals), 290.0 g of dispersing diol P (in accordance with preparation described) and 70.0 g of methyl ethyl ketone (MEK). After heating to 60° C., the catalyst solution, 6.0 g of dibutyltin oxide solution (5% strength in MEK), was added. 175.4 g of isophorone diisocyanate were added over the course of 1 hour. The mixture was heated to 85° C. and the course of reaction was followed by monitoring the NCO value. The course of the reaction was followed by acidimetry. After the end of the polyaddition reaction, an NCO content of approximately 1.4% by weight was found. 18.9 g of trimethylolpropane (from Aldrich) and 2.1 g of butanol were added. At 85° C., the reaction was continued to an NCO value <0.1%. After the end of the reaction, the mixture was cooled and 134 g of butyl glycol were added.

2) Polyurethane Dispersion B:

442 g of water and 8 g of dimethylethanolamine (DMEA) were added slowly dropwise with stirring at about 400 rpm to 356 g of polyurethane resin P2. After a further hour with stirring at 700 rpm, the mixture was filtered.

MEK was distilled off on a rotary evaporator under a water jet vacuum and the dispersion was adjusted to a solids content of 30% by weight of water. This gave a stable polyurethane dispersion.

### Comparative Example 1

### Polyurethane Dispersion A

1) Polyurethane resin P1:

A four-necked flask equipped with KPG stirrer, reflux condenser, thermometer and nitrogen blanketing was charged with 360.0 g of TEGO® Diol BD1000 (α,ω-polybutyl methacrylate diol of molar mass 1 000 g/mol from Tego Chemie Service GmbH), 5.9 g of neopentyl glycol (NPG from Neste Chemicals), 37.8 g of dimethylolpropionic acid (DMPA® from Mallinckrodt) and 70.0 g of methyl ethyl ketone (MEK). After heating for 60° C., the catalyst solution, 6.0 g of dibutyltin oxide solution (5% strength in MEK), was added. 175.4 g of isophorone diisocyanate were added over the course of 1 hour. The mixture was heated to 85° C. and the course of reaction was followed by monitoring the NCO value. The course of the reaction was followed by acidimetry. After the end of the polyaddition reaction, an NCO content of approximately 1.4% by weight was found. 18.9 g of trimethylolpropane (from Aldrich) and 2.1 g of butanol were added. At 85° C., the reaction was continued to an NCO value <0.1%. After the end of the reaction, the mixture was cooled and 134 g of butyl glycol were added.

2) Polyurethane Dispersion A:

442 g of water and 8 g of dimethylethanolamine (DMEA) were added slowly dropwise with stirring at about 400 rpm to 356 g of polyurethane resin PI. After a further hour with stirring at 700 rpm, the mixture was filtered.

MEK was distilled off on a rotary evaporator under a water jet vacuum and the dispersion was adjusted to a solids content of 30% by weight of water. This gave a stable polyurethane dispersion.

II) Preparation of the Polyurethane/Polymer Hybrid Dispersion:

For the preparation of the polyurethane/polymer hybrid dispersions, one of the polyurethane dispersions presented under example 1 and comparative example 1 was used as a matrix for the emulsion polymerization of the olefinic monomers. The hybridization step ran as follows:

### Example 2

### Polyurethane Hybrid Dispersion

300 g of the polyurethane dispersion (example 1) were charged to the reaction vessel at room temperature and were diluted with 122 g of demineralized water, with uniform stirring. 2 ml of aqueous ammonia solution (25% strength) were added until a pH of about 8.0 was reached. 15.7 g of n-butyl acrylate (BA), 89.3 g of methyl methacrylate (MA) and 1.33 g of 2,2′-azoisobutyronitrile (AIBN) were mixed well separately in a vessel at room temperature and were added to the polyurethane dispersion over 90 to 120 minutes. When all of the monomer/initiator solution had been added, the dispersion was heated at from 80 to 82° C. and held at this temperature for 5 hours. The dispersion was then cooled to 25° C. and filtered through a filter (pore size 80 μm). This gave a fine opaque hybrid dispersion having a solids content of about 35% by weight.

### Comparative Example 2

### Polyurethane (Hybrid) Dispersion of the Invention

The hybridization step ran in analogy to the procedure described in example 2. Instead of the polyurethane dispersion from example 1, the polyurethane dispersion from comparative example 1 was used. This gave a fine opaque hybrid dispersion having a solids content of about 35% by weight.

The superiority of the dispersion of the invention according to example 2 is shown below:

| | Formulation 1 | Formulation 2 |
|---|---|---|
| PU dispersion Ex. 1 | 70.0 g | — |
| PU dispersion Ex. 2 | — | 70.0 g |
| Maprenal ® MF 900* | 7.5 g | 7.5 g |
| Titanium dioxide RN 59 | 20.0 g | 20.0 g |
| Carbon black FW200 | 0.3 g | 0.3 g |

(*hexamethoxymethylmelamine resin from Cognis)

The formulation ingredients were mixed with one another in succession with stirring.

Formulations 1 and 2 were knifecoated onto an aluminum panel with a dry film thickness of 15 μm and were dried at 130° C. for 20 minutes.

The adhesion was determined in accordance with DIN 53151 by crosshatching, the hardness in accordance with DIN 53157 by the pendulum hardness on glass plate, the flexibility by Erichsen testing in accordance with DIN ISO 1520, and the condensation resistance in accordance with DIN 50017 over 240 hours at 40° C.

| | Formulation 1 | Formulation 2 |
|---|---|---|
| | (inventive) | (comparative) |
| Hardness (s): | 135 | 120 |
| Flexibility (mm): | 10 | 10 |
| Adhesion: | Gt 0 | Gt 0 |
| Condensation resistance: | Outstanding | Very good |

The coating according to formulation 1 had significantly higher hardness values coupled with high flexibility values.

Moreover, the polyurethane dispersion according to example 1 exhibited improved storage stability in comparison to that from comparative example 1, particularly at temperatures of 50° C.

The polyurethane hybrid dispersions were dried at room temperature for 7 days and the hardness was determined in accordance with DIN 53 157 (König hardness).

| | PU hybrid dispersion | PU hybrid dispersion |
|---|---|---|
| | according to comp. ex. 2 | according to ex. 2 |
| Hardness: | 95 s | 80 s |

The dispersion of the invention achieved very good flexibilities in combination with improved hardness values. As regards the sandability of the film surface, the dispersion 2 according to the invention proved very easy to process. Accordingly, the dispersion of the invention was also outstandingly suitable for use for coatings, such as wood varnishes, for example. It also had an improved dispersion stability.

The above description of the invention is intending to be illustrative and not limiting. Various changes or modifications in the embodiments may occur to those skilled in the art. These changes can be made without departing from the scope or spirit of the invention.

What is claimed is:

1. A polyurethane (hybrid) dispersion with high film hardness, comprising the following reaction components:
(A) from about 3 to about 25% by weight of a polyol component composed of
(i) from about 2 to about 20% by weight of a polymeric polyol having two or more polyisocyanate-reactive hydroxyl groups and a molar mass of from about 500 to about 4,000 daltons;
(ii) from about 0.5 to about 5% by weight of a low molecular mass polyol having two or more polyisocyanate-reactive hydroxyl groups and a molar mass of from about 50 to about 500 daltons;
(B) from about 3 to about 30% by weight of an anionically modifiable 1,2-polymethacrylatediol having two polyisocyanate-reactive hydroxyl groups and also one or more carboxyl groups, which are inert toward polyisocyanates, and having a molar mass of from about 500 to about 5,000 daltons;
(C) from about 2 to about 20% by weight of a polyisocyanate component composed of one or more polyisocyanates, polyisocyanate homologs or polyisocyanate derivatives having two or more aliphatic or aromatic isocyanate groups;
(D) from 0 to about 6% by weight of a solvent component consisting of
(i) at least one polyisocyanate-inert organic solvent which following the preparation of the polyurethane/polymer hybrid dispersion remains therein or is removed in part or in whole by distillation and/or
(ii) from 0 to about 6% by weight of a polyisocyanate-inert reactive diluent composed of at least one polyisocyanate-inert organic compound having one or more free-radically polymerizable double bonds;
(E) from about 0.15 to about 1.5% by weight of a neutralizing component composed of at least one organic or inorganic base;
(F) from 0 to about 1% by weight of a chain extender component composed of one or more polyamines having two or more polyisocyanate-reactive amino groups;
and optionally,
(G) from about 5 to about 40% by weight of a monomer component composed of one or more monomers having one or more free-radically polymerizable double bonds; and
(H) from about 0.01 to about 1.5% by weight of an initiator component composed of at least one lipophilic free-radical initiator
with water as the remainder.

2. A polyurethane dispersion with high film hardness, comprising the following reaction components:
(A) from 3 to 25% by weight of a polyol component composed of
(i) from 2 to 20% by weight of a polymeric polyol having two or more polyisocyanate-reactive hydroxyl groups and a molar mass of from 500 to 4,000 daltons;
(ii) from 0.5 to 5% by weight of a low molecular mass polyol having two or more poly-isocyanate-reactive hydroxyl groups and a molar mass of from 50 to 500 daltons;
(B) from 3 to 30% by weight of an anionically modifiable 1,2-polymethacrylatediol having two polyisocyanate-reactive hydroxyl groups and also one or more carboxyl groups which are inert toward polyisocyanates, and having a molar mass of from 500 to 5,000 daltons;
(C) from 2 to 20% by weight of a polyisocyanate component composed of one or more poly-isocyanates, polyisocyanate homologs or poly-isocyanate derivatives having two or more aliphatic or aromatic isocyanate groups;
(D) from 0 to 6% by weight of a solvent component consisting of
(i) at least one polyisocyanate-inert organic solvent which following the preparation of the polyurethane/polymer hybrid dispersion remains therein or is removed in part or in whole by distillation and/or
(ii) from 0 to 6% by weight of a polyisocyanate-inert reactive diluent composed of at least one polyisocyanate-inert organic compound having one or more free-radically polymerizable double bonds;
(E) from 0.15 to 1.5% by weight of a neutralizing component composed of at least one organic or inorganic base;
(F) from 0 to 1% by weight of a chain extender component composed of one or more polyamines having two or more polyisocyanate-reactive amino groups;
and optionally,
(G) from 5 to 40% by weight of a monomer component composed of one or more monomers having one or more free-radically polymerizable double bonds, and
(H) from 0.01 to 1.5% by weight of an initiator component composed of at least one lipophilic free-radical initiator
with water as the remainder.

3. The polyurethane (hybrid) dispersion as claimed in claim 1, wherein component (A) (i) is selected from linear and/or difunctional polyester polyols, polyether polyols or polymethacrylate diols having a molar mass of from about 1,000 to about 4,000 daltons.

4. The polyurethane (hybrid) dispersion as claimed in claim 1, wherein component (A) (ii) is selected from low molecular mass difunctional and/or trifunctional alcohols having from 2 to 20 carbon atoms and optionally contains carboxyl groups.

5. The polyurethane (hybrid) dispersion as claimed in claim 1, wherein component (B) is selected from copolymers of an alkyl (meth)acrylate and (meth)acrylic acid wherein mercaptoglycerol is used as a chain transfer agent.

6. The polyurethane (hybrid) dispersion as claimed in claim 1, wherein component (B) has a molecular mass of from about 500 to about 5,000 g/mol.

7. The polyurethane (hybrid) dispersion as claimed in claim 1, wherein component (C) comprises an isophorone diisocyanate.

8. The polyurethane (hybrid) dispersion as claimed in claim 7, wherein the isophorone diisocyanate is 1-isocyanato-5-isocyanatomethyl-1,3,3-trimethylcyclohexane.

9. The polyurethane (hybrid) dispersion as claimed in claim 1, wherein the solvent component (D) (i) comprises N-methylpyrrolidone.

10. The polyurethane (hybrid) dispersion as claimed in claim 1, wherein the neutralizing component (E) comprises triethylamine.

11. The polyurethane (hybrid) dispersion as claimed in claim 1, wherein the chain extender component (F) comprises a difunctional primary amine.

12. The polyurethane (hybrid) dispersion as claimed in claim 1, wherein the solids content of the polyurethane polymer composed of components (A) to (H) is from about 20 to about 60% by weight, based on the overall amount of the polyurethane (hybrid) dispersion.

13. The polyurethane (hybrid) dispersion as claimed in claim 12, wherein the solids content of the polyurethane polymer composed of components (A) to (H) is from about 30 to about 50% by weight.

14. The polyurethane (hybrid) dispersion as claimed in claim 1, wherein the polyurethane polymer composed of components (A) to (H) has an average molar mass of from about 25,000 to about 100,00 daltons.

15. The polyurethane (hybrid) dispersion as claimed in claim 1, wherein component (F) is acrylic acid and/or propenoic acid or their derivatives, methacrylic acid and/or 2-methylpropenoic acid or their derivatives, styrene and its derivatives, or a mixture of any of the foregoing.

16. The polyurethane (hybrid) dispersion as claimed in claim 1, wherein component (G) is selected from free-radical initiators having one or more azo or peroxo groups.

17. The polyurethane (hybrid) dispersion as claimed in claim 1, wherein the ratio of the fractional solids contents of polyurethane resin and polymer resin from about 20:80 to about 80:20% by weight.

18. The polyurethane (hybrid) dispersion as claimed in claim 17, wherein the ratio is from about 40:60 to about 60:40% by weight.

19. A one- or two-component coating material which comprises a polyurethane (hybrid) dispersion as claimed in claim 1.

20. The coating material according to claim 19 which is a wood varnish.

21. A method for coating a surface of an article which comprises applying to the surface of said article the coating material article according to claim 1.

22. The method according to claim 21, wherein the article is a mineral building material, wood-based material, metal or plastic.

23. A coated article wherein the coat is a coating material according to claim 19.

24. The coated article according to claim 23, wherein the article is a mineral building material, wood-based material, metal or plastic.

25. A sealing material or an adhesive which comprises a polyurethane (hybrid) dispersion according to claim 1.

26. A method for sealing or adhering at least two surfaces of at least two articles, which comprises applying the sealing material or adhesive according to claim 25 to at least one of the surfaces.

27. A method for sealing a material having at least one surface which comprises applying the sealing material according to claim 25 to said surface.
